(19) United States
(12) Patent Application Publication
(10) Pub. No.: US 2018/0021876 A1
(43) Pub. Date: Jan. 25, 2018

(54) BATTERY-POWERED WELDER AND METHOD OF USE

(71) Applicant: Morgan Jay Ellis, San Diego, CA (US)

(72) Inventor: Morgan Jay Ellis, San Diego, CA (US)

(21) Appl. No.: 15/657,644

(22) Filed: Jul. 24, 2017

Related U.S. Application Data
(60) Provisional application No. 62/366,466, filed on Jul. 25, 2016.

(51) Int. Cl. B23K 9/16; B23K 9/12; B23K 9/32; B23K 9/10

(52) U.S. Cl. CPC B23K 9/164; B23K 9/1081; B23K 9/124; B23K 9/32

(57) ABSTRACT

A battery-powered welder with a plurality of quick-connect modular components includes a power source component; a neck assembly component to create an electric arc between an electrode wire and workpiece metal, causing the electrode wire and workpiece metal to melt and join; an electrode spool component including an electrode wire spool reel housing and spool to carry the electrode wire; a wire feed component including a motor to feed the electrode wire from electrode spool component into the neck assembly component; a handle component for holding and operating the battery-powered welder during use; a flexible cable to provide remote attachment of various components to avoid additional hand held weight; a power source component to power the battery-powered welder, wherein the power source component, the neck assembly component, the electrode spool component, the wire feed component, the handle component, the flexible cable, and the power source component include quick connects to allow seamless, simplistic interchange and reconfiguration of the battery-powered welder.

### CROSS REFERENCE TO RELATED APPLICATION

The present application claims the benefit of U.S. Provisional Patent Application No. 62/366,466, filed Jul. 25, 2016, the subject matter of which is incorporated herein.

### BACKGROUND OF THE INVENTION

In the past, in an effort to make welding torches portable, the welding torches have been coupled to car batteries to supply power to the welding torches. A problem with this is that the car batteries are bulky, expensive, and not very portable, making the welding torch not very portable, and, thus, not suitable for intended use.

### SUMMARY OF THE INVENTION

An aspect of the invention involves battery-powered welder including a welding gun and a rechargeable battery. The battery-powered welder may include a welding gun incorporating Flux Cored Arc welding (FCAW) technology and/or Metal Inert Gas welding technology. The welding gun is powered by an attachable rechargeable (e.g., Lithium ion) battery.

Another aspect of the invention involves a battery-powered welder with a plurality of quick-connect modular components comprising a power source component; a neck assembly component to create an electric arc between an electrode wire and workpiece metal, causing the electrode wire and workpiece metal to melt and join; an electrode spool component including an electrode wire spool reel housing and spool to carry the electrode wire; a wire feed component including a motor to feed the electrode wire from electrode spool component into the neck assembly component; a handle component for holding and operating the battery-powered welder during use; a flexible cable to provide remote attachment of various components to avoid additional hand held weight; a power source component to power the battery-powered welder, wherein the power source component, the neck assembly component, the electrode spool component, the wire feed component, the handle component, the flexible cable, and the power source component include quick connects to allow seamless, simplistic interchange and reconfiguration of the battery-powered welder.

One or more implementations of the aspect of the invention described immediately above includes one or more of the following: the neck assembly component includes a nozzle, a cable liner, and a neck including a contact tip and configured to disperse gas at the contact tip, the cable liner guiding the electrode wire freely through the neck assembly component and protecting it from current; the electrode spool component is a welding wire and flux core wire spool reel housing, and includes a wire guide to guide the electrode wire from the spool through the quick connect of the electrode spool component; the motor is a variable speed motor 230, and the wire feed component includes a cable liner and a drive roller with two rollers that pinch the electrode wire there between to provide positive traction to pull the electrode wire, the cable liner guides the electrode wire freely through the wire feed component, the variable speed drive motor turns the drive rollers that feed the electrode wire; the handle component is also a main electronics and trigger compartment including a trigger, a cable liner, and electronics, the trigger is a switch that sends power to the motor to feed the electrode wire through the neck assembly from the spool, the cable liner guides the electrode wire freely through the handle component, the electronics configured to control at least power on/off, speed controller, ground clamp, polarity switch, and safety cutoff; the flexible cable is a flexible power, gas, and electrode adapter cable to provide remote attachment of various components to avoid additional hand held weight, the flexible cable includes a cable liner that guides the electrode wire freely through the flexible cable; the power source component includes a dc voltage li-ion rechargeable battery, and a cable liner that guides the electrode wire freely through the power supply; the quick connects are rotational twist-lock mating connectors to allow seamless, simplistic interchange and reconfiguration of the complete assembly; one or more of the quick connects include an electronic connector, a liner connector, a current connector, and a gas connector; the electronic connector is a contact connection; the liner connector connects the cable liner into alignment for smooth transition of electrode wire through the components; the current connector connects current conducting cables together in straight or reverse polarity; the gas connector connects pressurized shielding gas hoses together without gas leakage; and/or a shielding gas tank component shields the welding process from contaminants in the air, reducing splatter, the shielding gas tank component includes a quick connect.

### BRIEF DESCRIPTION OF DRAWINGS

FIG. 1 is an exploded view of an embodiment of a battery-powered welder.

FIGS. 2-21 are exploded views of alternative configurations/embodiments of the battery-powered welder using standardized quick connects.

### DETAILED DESCRIPTION OF THE INVENTION

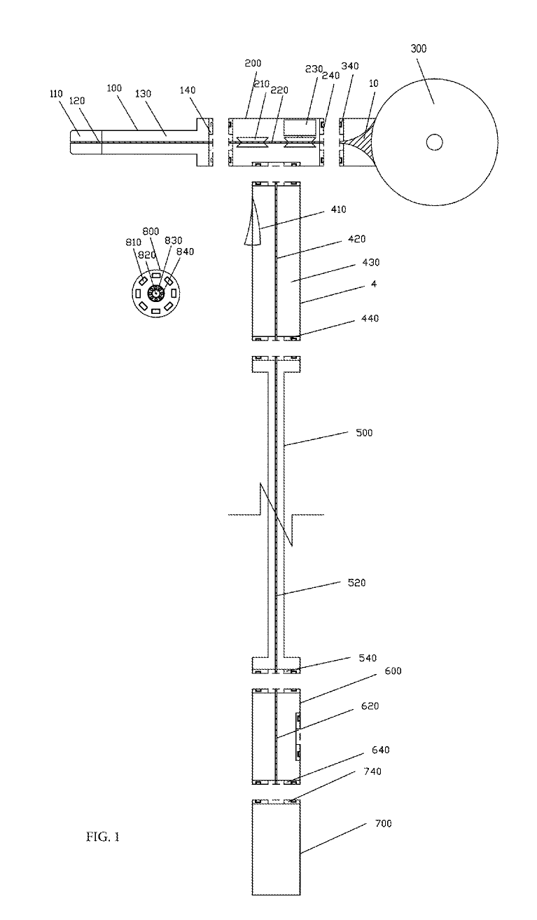

With reference to FIG. 1, an embodiment of a battery-powered welder 50 and method of use will be described. The battery-powered welder 50 may incorporate Flux Cored Arc welding (FCAW) technology and/or Metal Inert Gas welding technology. Although the battery-powered welder 50 will be shown as described as a spool feed battery welder, in alternative embodiments, the battery welder 50 may be other types of battery welders.

The battery-powered welder 50 includes a plurality of quick-connect modular components 100, 200, 300, 400, 500, 600, and 700 to allow configuration flexibility and further development of future features for ease of integration.

Each of the quick-connect modular components 100, 200, 300, 400, 500, 600, and 700 that together make up the battery-powered welder 50 will be described in turn below and how they interact with each other to perform welding tasks.

A neck assembly component 100 houses standard mig welding torch head components which create an electric arc between an electrode wire and workpiece metals, causing them to melt and join. The neck assembly component 100 includes a nozzle 110, a cable liner 120, a neck 130, and a quick connect 140. The nozzle 110 houses a gas diffuser that disperses gas at a contact tip. The cable liner 120 guides the electrode wire freely through the neck assembly component 100 and protects it from current. The neck 130 lengthens the torch to distance the welding nozzle from the user's hand. The quick connect 140 is a standard connector that attaches component housings to each other in various configurations, connecting the electronics, cable liner current conductor, and shielding gas.

A wire feed component 200 feeds the electrode wire from electrode spool component 300 into neck assembly component 100 with a variable speed motor 230. The wire feed component 200 includes a drive roller 210, a cable liner 220, the drive motor 230, and the quick connect 240. The drive roller 210 pinches the electrode wire between two rollers to provide positive traction to pull the wire. The cable liner 220 guides the electrode wire freely through the wire feed component and protects it from current. The variable speed drive motor 230 turns the drive rollers that feed the electrode wire. The quick connect 240 is a standard connector that attaches component housings to each other in various configurations, connecting the electronics, cable liner current conductor, and shielding gas.

An electrode spool component 300 is a standard welding wire and flux core wire spool reel housing. In addition to housing a spool of welding wire, the electrode spool component 300 includes a wire guide 310 and a quick connect 340. The wire guide 310 is a guide to feed weld wire from the spool through quick connect 340. The quick connect 340 is a standard connector that attaches component housings to each other in various configurations, connecting the electronics, cable liner current conductor, and shielding gas.

A handle component 400 serves not only as handle, but also as a main electronics and trigger compartment. The handle component 400 includes trigger 410, cable liner 420, electronics 430, and quick connect 440. The trigger 410 is a switch that sends power to the drive motor to feed the electrode wire through the neck assembly from the electrode spool. The cable liner 420 guides the electrode wire freely through the handle component 400 and protects it from current. The electronics 430 control power on/off, speed controller, ground clamp, polarity switch, safety cutoff, and other functions. The quick connect 440 is a standard connector that attaches component housings to each other in various configurations, connecting the electronics, cable liner current conductor, and shielding gas.

A flexible cable 500 is a flexible power, gas, and electrode adapter cable to provide remote attachment of various components to avoid additional hand held weight. The flexible cable 500 includes a cable liner 520 and a quick connect 540. The cable liner 520 guides the electrode wire freely through the flexible cable and protects it from current. The quick connect 540 is a standard connector that attaches component housings to each other in various configurations, connecting the electronics, cable liner current conductor, and shielding gas.

A power source component 600 is a dc voltage li-ion rechargeable battery, or ac mains power. In addition to housing the battery/ac electronics, the power source component 600 includes a cable liner 620 and a quick connect 640. The cable liner 620 guides the electrode wire freely through the power supply and protects it from current. The quick connect 640 is a standard connector that attaches component housings to each other in various configurations, connecting the electronics, cable liner current conductor, and shielding gas.

An optional shielding gas tank component 700 shields the welding process from contaminants in the air, reducing splatter. The shielding gas tank component 700 includes a quick connect 740, which is a standard connector that attaches component housings to each other in various configurations, connecting the electronics, cable liner current conductor, and shielding gas.

The battery-powered welder 50 utilizes a standardized quick connection/connect (e.g., rotational twist-lock mating connector) to allow seamless, simplistic interchange and reconfiguration of the complete assembly. An exemplary quick connect 800, which may be the same or substantially the same as one or more of the quick connects 140, 240, 340, 440, 540, 640, 740 described above will now be described in more detail. The quick connection/connect 800 is a standard connector that attaches component housings to each other in various configurations, connecting the electronics, cable liner current conductor, inherit gas. The quick connection/connect 800 includes electronic connectors 810, liner connector 820, current connector 830, and gas connector 840. The electronic connectors 810 are a contact connection to link the electronic circuitry to control the drive motor, trigger switch, and power source. The liner connector 820 connects the cable liner into alignment for smooth transition of electrode wire through the various components. The current connector 830 connects the current conducting cables together in straight or reverse polarity. The gas connector 840 connects the pressurized shielding gas hoses together without gas leakage.

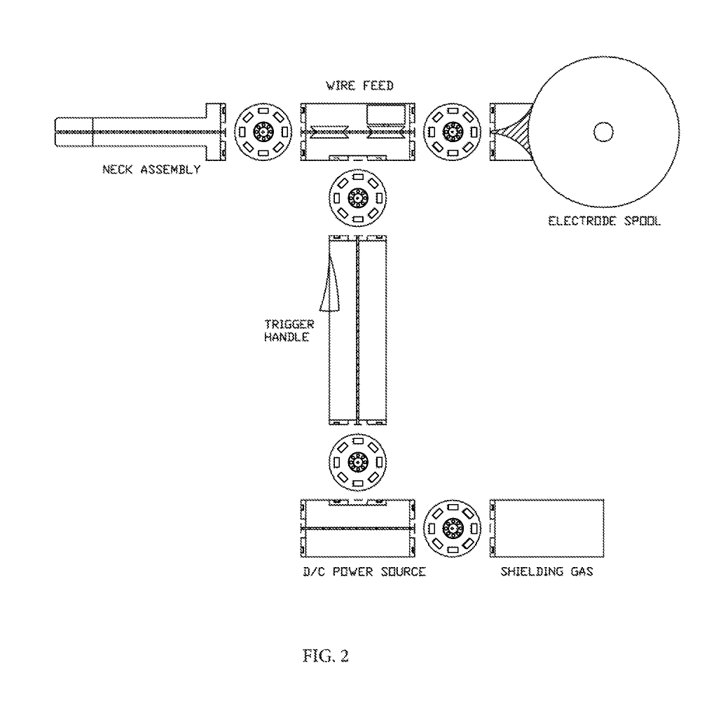

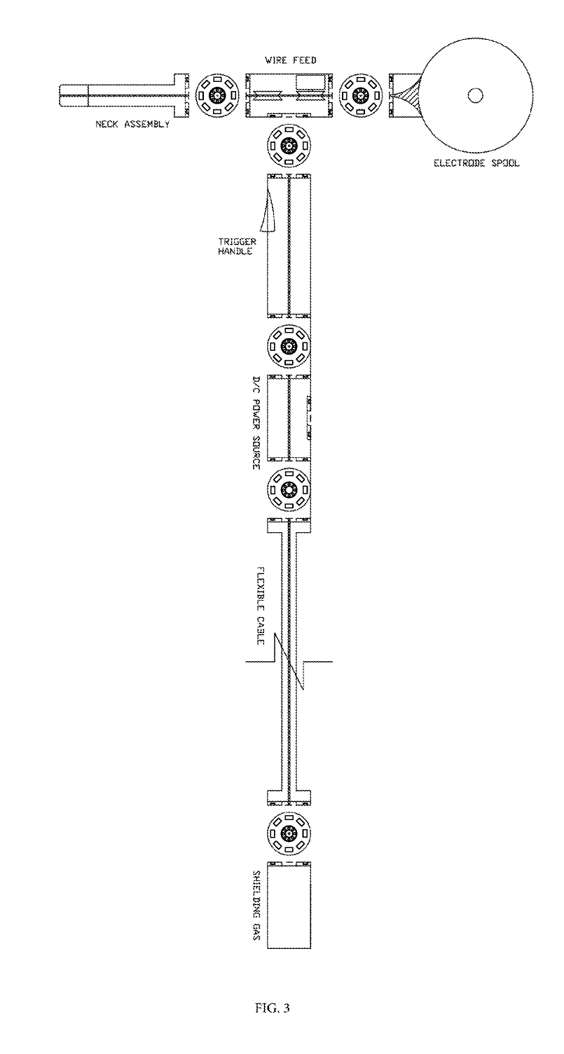

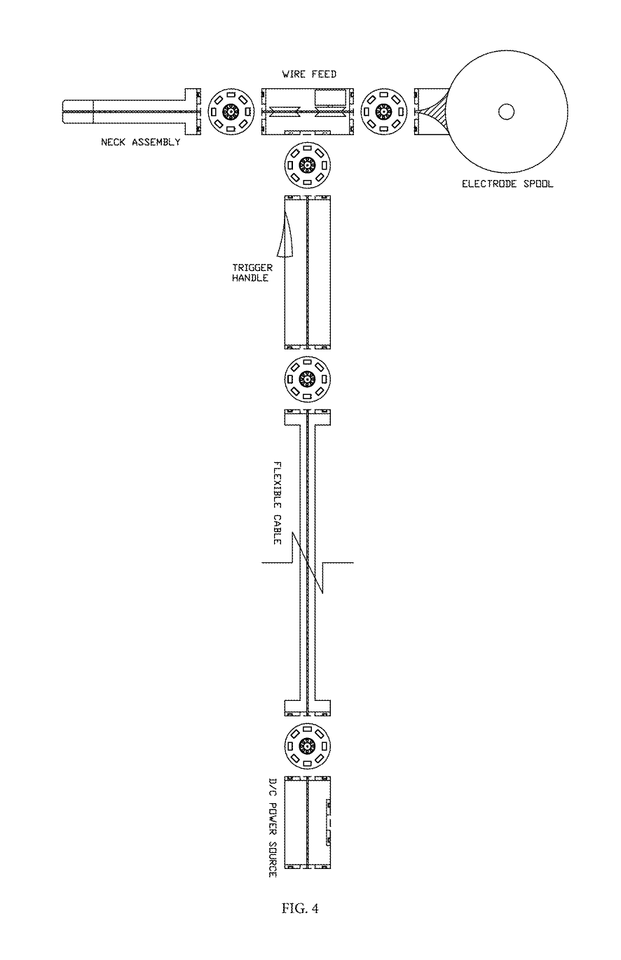

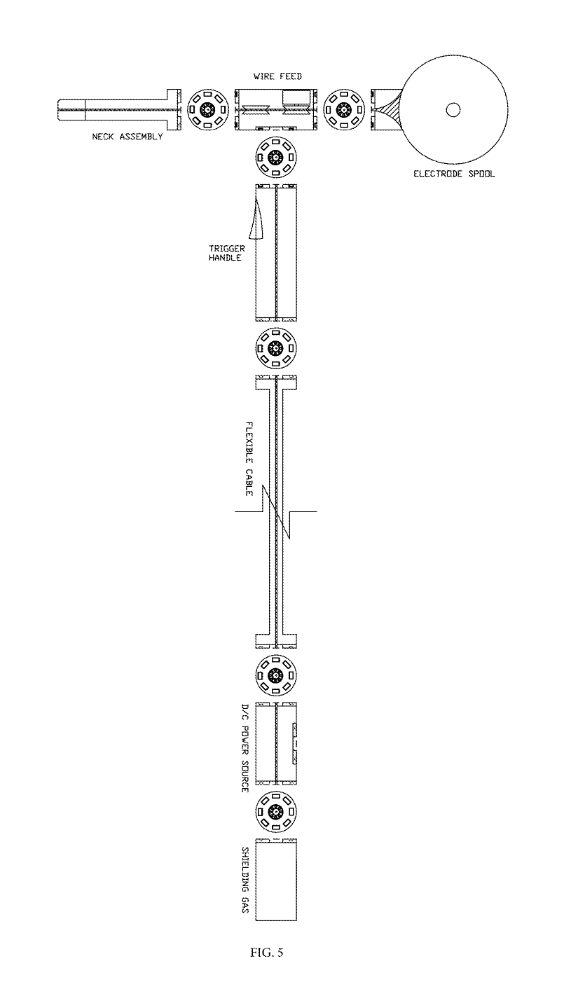

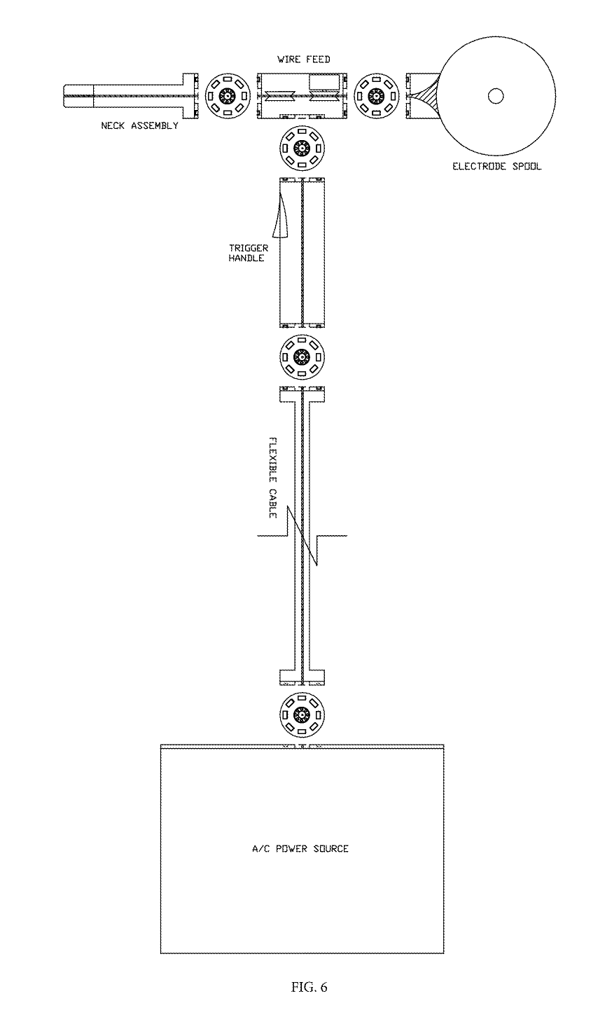

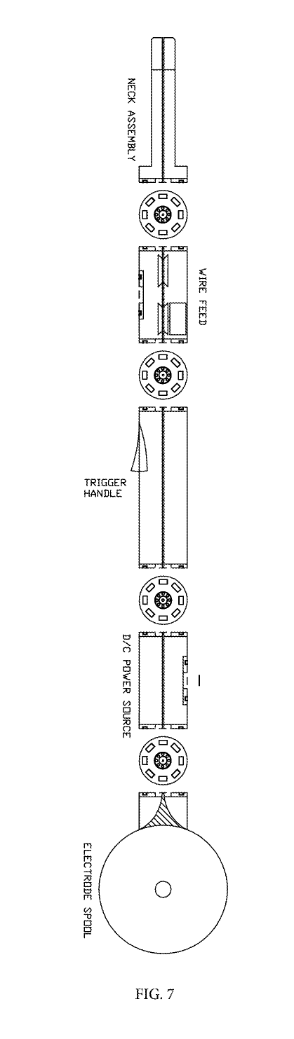

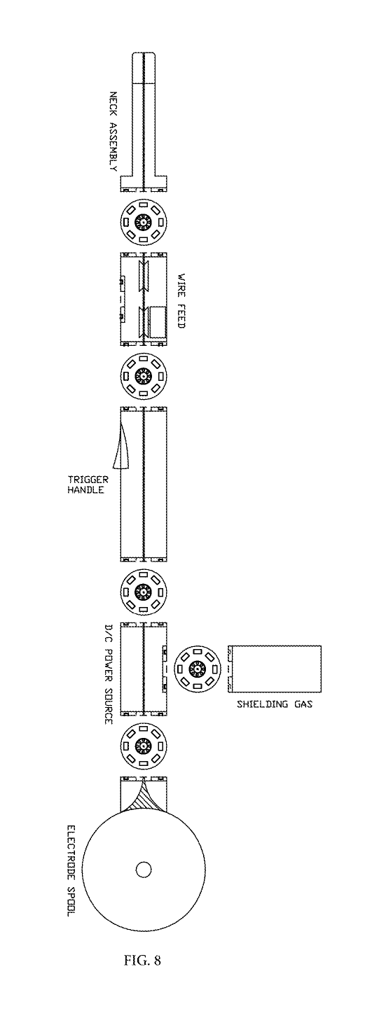

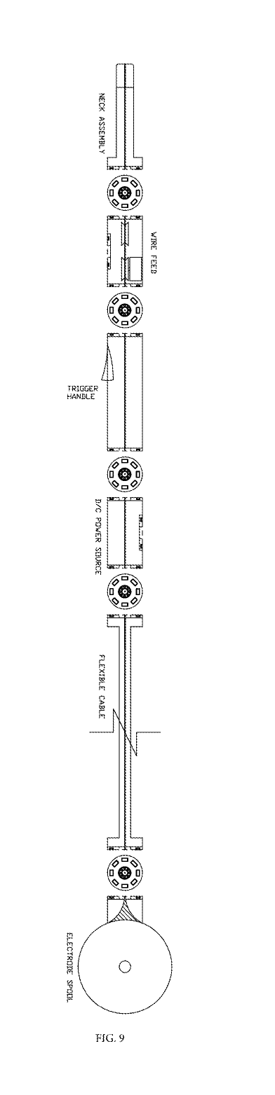

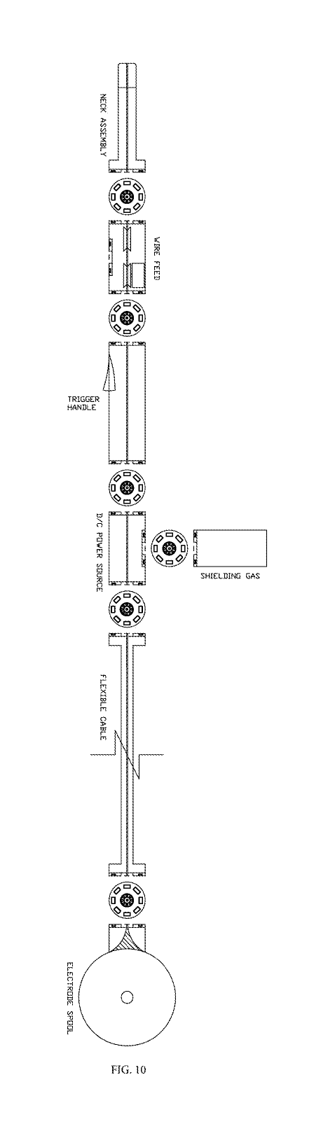

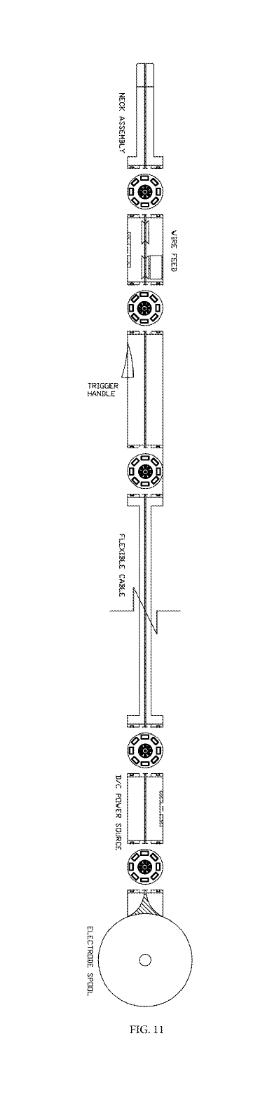

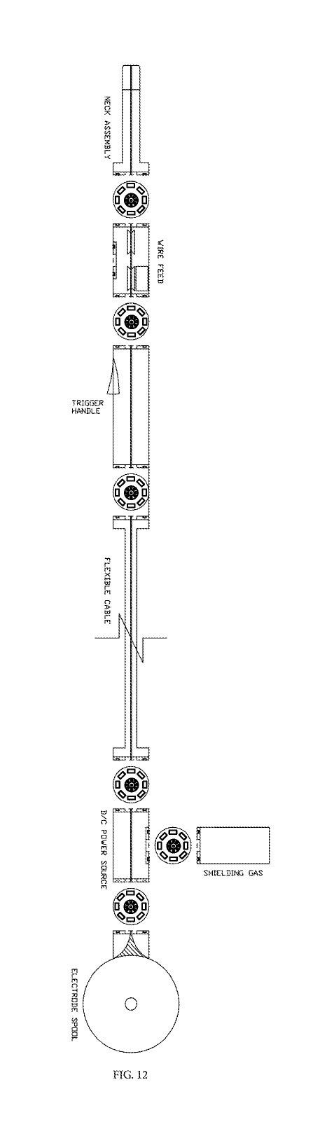

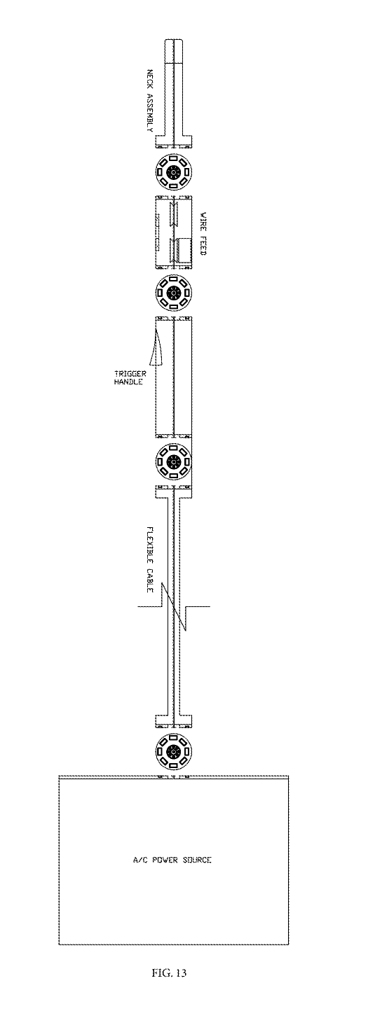

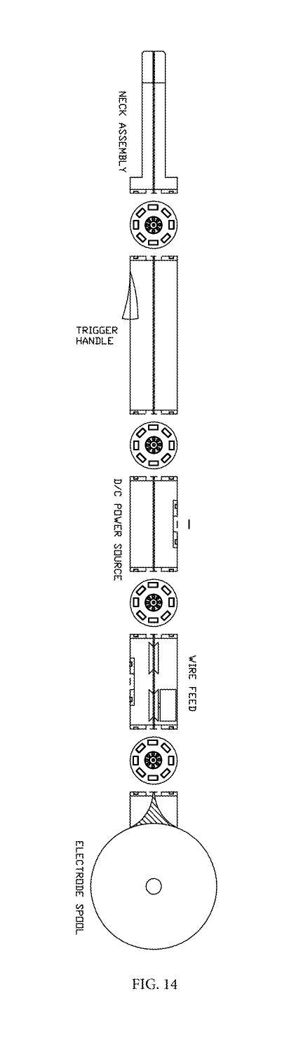

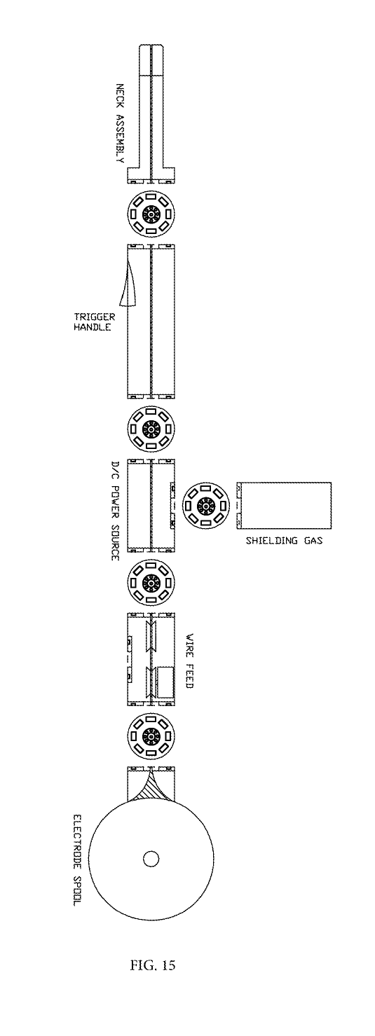

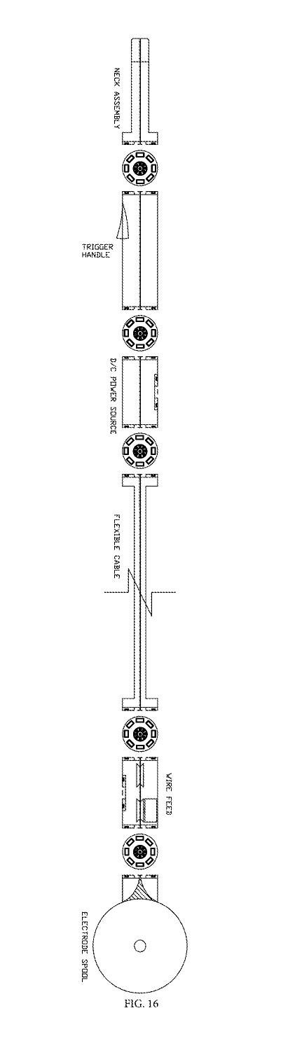

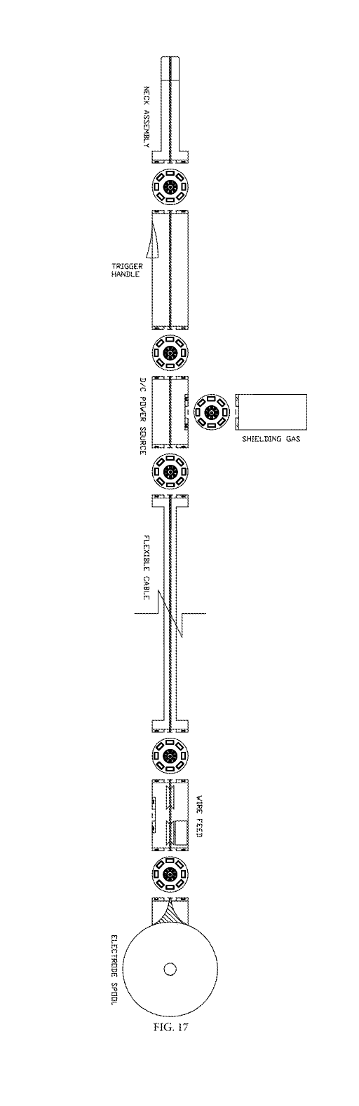

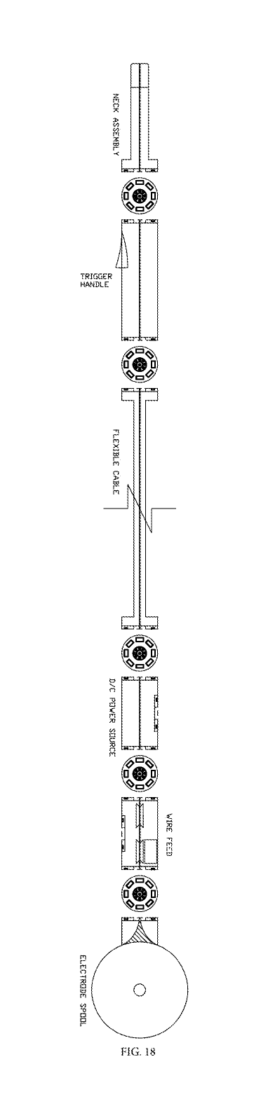

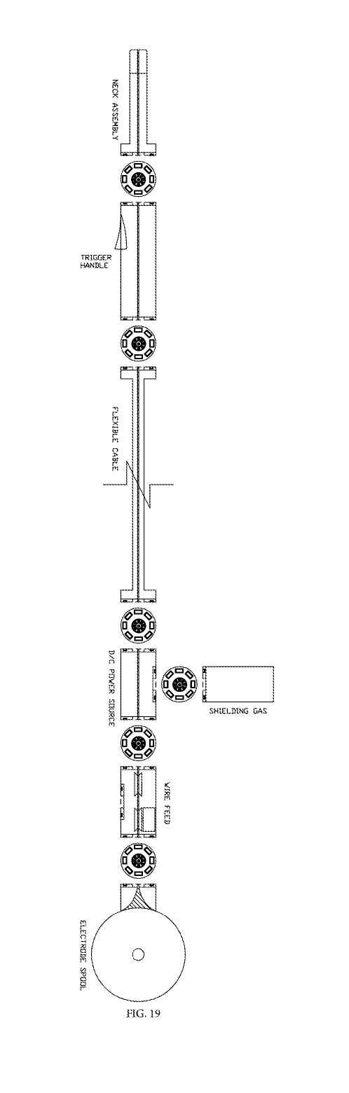

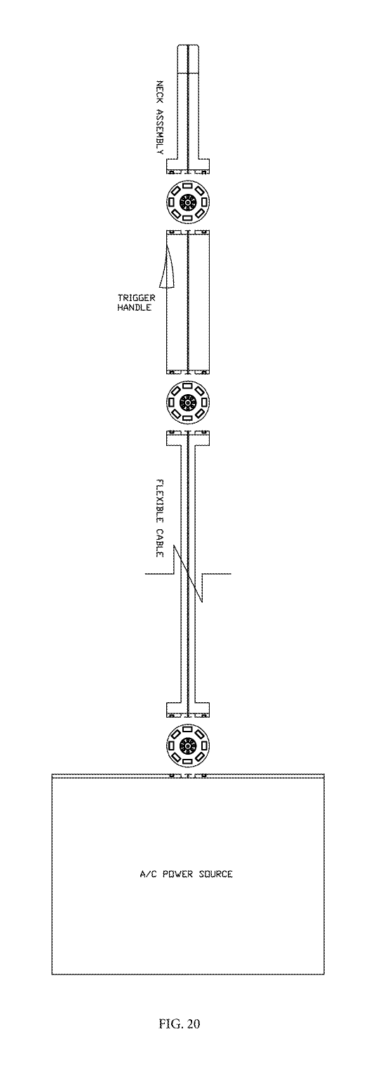

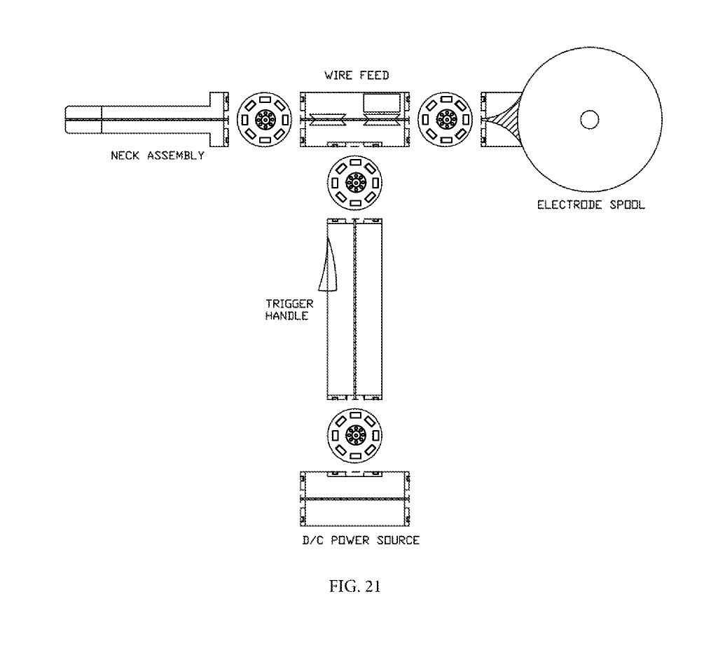

FIGS. 2-21 show alternative configurations/embodiments of the battery-powered welder 50 using the quick connects. The illustrated components of the alternative configurations are interchangeable and can be used together with other components of the welder 50 to form different assembly kits. Once the desired configuration is assembled and powered, the welder 50 is ready to weld.

At a minimum, the welder 50 requires a trigger, neck, if you decide to pull power and electrode wire from an already existing machine. To operate independent of other equipment, the welder 50 requires a portable power source component, trigger component, spool component wire feed component, and neck component.

The battery-powered welder 50 will now be described in use. Arc welding with the welder 50 uses the power supply to create and maintain an electric arc between the electrode and the base material to melt metals at the welding point. To begin, the ground clamp (which is connected to the trigger component with a ground wire) is attached to the work. The power source is turned on, the polarity preferred is checked (typically the current flows from the power source through the ground clamp, through the work material one is trying to weld) and back through the electrode (this is commonly known as reverse polarity and preferred with welding without shielding gas), which is driven out of the neck. The arc is started by touching the electrode momentarily against the work to complete the electrical circuit before raising the electrode to establish the arc. ‘Tap starting’ and ‘scratch starting’ are the two common methods of starting the arc. Once the current is completed and the arc has begun, the electrode wire will melt forming a bead to connect the base materials together. Pulling the trigger causes the electrode wire to be pushed out of the neck to allow more wire to be melted to join the parts. The speed of the wire feed can be adjusted on the trigger handle assembly.

While various embodiments of the present invention have been described above, it should be understood that they have been presented by way of example only, and not of limitation. Likewise, the various diagrams may depict an example architectural or other configuration for the disclosure, which is done to aid in understanding the features and functionality that can be included in the disclosure. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent.

As will become apparent to one of ordinary skill in the art after reading this document, the illustrated embodiments and their various alternatives can be implemented without confinement to the illustrated examples.

1. A battery-powered welder with a plurality of quick-connect modular components, comprising:
a power source component;
a neck assembly component to create an electric arc between an electrode wire and workpiece metal, causing the electrode wire and workpiece metal to melt and join;
an electrode spool component including an electrode wire spool reel housing and spool to carry the electrode wire;
a wire feed component including a motor to feed the electrode wire from electrode spool component into the neck assembly component;
a handle component for holding and operating the battery-powered welder during use;
a flexible cable to provide remote attachment of various components to avoid additional hand held weight;
a power source component to power the battery-powered welder,
wherein the power source component, the neck assembly component, the electrode spool component, the wire feed component, the handle component, the flexible cable, and the power source component include quick connects to allow seamless, simplistic interchange and reconfiguration of the battery-powered welder.

2. The battery-powered welder of claim 1, wherein the neck assembly component includes a nozzle, a cable liner, and a neck including a contact tip and configured to disperse gas at the contact tip, the cable liner guiding the electrode wire freely through the neck assembly component and protecting it from current.

3. The battery-powered welder of claim 1, wherein the electrode spool component is a welding wire and flux core wire spool reel housing, and includes a wire guide to guide the electrode wire from the spool through the quick connect of the electrode spool component.

4. The battery-powered welder of claim 1, wherein the motor is a variable speed motor 230, and the wire feed component includes a cable liner and a drive roller with two rollers that pinch the electrode wire there between to provide positive traction to pull the electrode wire, the cable liner guides the electrode wire freely through the wire feed component, the variable speed drive motor turns the drive rollers that feed the electrode wire.

5. The battery-powered welder of claim 1, wherein the handle component is also a main electronics and trigger compartment including a trigger, a cable liner, and electronics, the trigger is a switch that sends power to the motor to feed the electrode wire through the neck assembly from the spool, the cable liner guides the electrode wire freely through the handle component, the electronics configured to control at least power on/off, speed controller, ground clamp, polarity switch, and safety cutoff.

6. The battery-powered welder of claim 1, wherein the flexible cable is a flexible power, gas, and electrode adapter cable to provide remote attachment of various components to avoid additional hand held weight, the flexible cable includes a cable liner that guides the electrode wire freely through the flexible cable.

7. The battery-powered welder of claim 1, wherein the power source component includes a dc voltage li-ion rechargeable battery, and a cable liner that guides the electrode wire freely through the power supply.

8. The battery-powered welder of claim 1, wherein the quick connects are rotational twist-lock mating connectors to allow seamless, simplistic interchange and reconfiguration of the complete assembly.

9. The battery-powered welder of claim 1, wherein one or more of the quick connects include an electronic connector, a liner connector, a current connector, and a gas connector.

10. The battery-powered welder of claim 9, wherein the electronic connector is a contact connection.

11. The battery-powered welder of claim 9, wherein the liner connector connects the cable liner into alignment for smooth transition of electrode wire through the components.

12. The battery-powered welder of claim 9, wherein the current connector connects current conducting cables together in straight or reverse polarity.

13. The battery-powered welder of claim 9, wherein the gas connector connects pressurized shielding gas hoses together without gas leakage.

14. The battery-powered welder of claim 1, further including a shielding gas tank component that shields the welding process from contaminants in the air, reducing splatter, the shielding gas tank component includes a quick connect.
